(19) United States
(12) Patent Application Publication
(10) Pub. No.: US 2008/0068364 A1
(43) Pub. Date: Mar. 20, 2008

(54) Thin Film Transistor Panel and Liquid Crystal Display Apparatus Having the Same

(76) Inventors: Yong-Han Park, Anyang-si (KR); Jin-Young Choi, Seoul (KR); Yong-Koo Her, Yongin-si (KR); Sun-Ja Kwon, Gunpo-si (KR)

Correspondence Address: Frank Chau, Esq.;F. CHAU & ASSOCIATES, LLC, 130 Woodbury Road, Woodbury, NY, 11797, US

(21) Appl. No.: 11/854,325

(22) Filed: Sep. 12, 2007

(30) Foreign Application Priority Data
Sep. 13, 2006 (KR) 2006-88430

(51) Int. Cl. G06F 3/038

(52) U.S. Cl. 345/206

(57) ABSTRACT

A thin film transistor panel includes an insulating substrate including a display area and a peripheral area. A plurality of pixels is defined by a plurality of data lines that cross a plurality of gate lines. A pixel electrode is formed in each of the pixels. A plurality of dummy pixels is defined by a dummy data line that crosses the plurality of gate lines. A dummy pixel electrode is formed in each of the dummy pixels, and a thin film transistor including a gate electrode, a source electrode, a drain electrode, and a semiconductor. The thin film transistor display panel reduces or prevents a difference in brightness between pixels caused by a difference of coupling capacitance between the data line adjacent to the peripheral area and the other data lines.

### CROSS-REFERENCE TO RELATED APPLICATION

This application claims priority to Korean Patent Application No. 10-2006-0088430, filed on Sep. 13, 2006, the contents of which are herein incorporated by reference in its entirety.

### BACKGROUND OF THE INVENTION

1. Technical Field

The present disclosure relates to a transistor panel and more particularly, to a thin film transistor panel and a liquid crystal display apparatus having the thin film transistor panel.

2. Discussion of Related Art

Generally, a liquid crystal display (LCD) apparatus includes a liquid crystal disposed between two substrates. An electric field provided between the two substrates changes an arrangement of liquid crystal molecules and controls the amount of light passing through the liquid crystal. The liquid crystal display apparatus displays an image by controlling the electric field and thereby controlling the passage of light through the liquid crystal. A thin film transistor (TFT) substrate, which is an element of the liquid crystal display apparatus, independently drives each pixel formed thereon.

The TFT substrate includes a scan signal line (or a gate line) receiving a scan signal and an image signal line (or a data line) receiving an image signal. The TFT substrate further includes a thin film transistor electrically connected to the gate and data lines. A pixel electrode is connected to the thin film transistor. A gate insulating layer covers the gate line and electrically insulates the gate line. An overcoat layer covers the thin film transistor and the data line and electrically insulates the thin film transistor and the data line.

The thin film transistor includes a gate electrode which is a portion of the gate line, a semiconductor layer forming a channel, a source electrode which is a portion of the data line, and a drain electrode. The thin film transistor is a switching element that transmits an image signal through the data line to the pixel electrode or blocks the image signal from the pixel electrode according to a scan signal transmitted through the gate line.

The number of gate and data lines is determined according to the resolution of the LCD apparatus. Coupling capacitance is formed between data lines.

The TFT substrate includes a display area on which a plurality of pixels is disposed, and a peripheral area on which driving circuits for applying a signal to the display area are formed. Each of the data lines except for a first data line adjacent to the peripheral area has two adjacent data lines disposed to the left and right sides of the data line. However, the first data line has an adjacent, data line disposed in to the right side of the first data line. Therefore, coupling capacitance formed in the first data line is smaller than that formed in one of the other data lines. Difference of the coupling capacitance may generate brightness difference between a first pixel connected to the first data line and a second pixel connected to one of the other data lines.

The difference of the coupling capacitance between the first and second pixels generates a problem; the first pixel appears brighter than the second pixel. In order to solve this problem, the width of a black matrix formed on a color filter substrate, which corresponds to the first pixel, is increased. However, it is difficult to determine the width of the black matrix since every liquid crystal display apparatus requires a unique pixel size and brightness.

The first pixel also appears brighter than the second pixel since the black matrix shielding light is adjacent to the first pixel. The first pixel generally forms a red color since the liquid crystal display apparatus employs red, green, and blue color filters sequentially disposed therein. In this case, a red color of the first pixel adjacent to the black matrix appears brighter than a red color of another pixel since the black matrix generally has a black color. This problem is particularly acute in an easily accessible product such as a mobile phone.

### SUMMARY OF THE INVENTION

Exemplary embodiments of the present invention provide a TFT panel capable of reducing or preventing a brightness difference caused by a difference of coupling capacitance and brightness defects of an outer pixel row adjacent to a light shielding member.

Exemplary embodiments of the present invention further provide a liquid crystal display apparatus having the TFT panel.

A TFT panel according to an exemplary embodiment includes an insulating substrate, a plurality of gate lines, a plurality of data lines, a pixel electrode, a dummy data line, a dummy pixel electrode, and a thin film transistor. The insulating substrate includes a display area and a peripheral area surrounding the display area. The gate lines are formed on the insulating substrate and are insulated from the gate lines. The data lines are extended from an extension direction of the gate lines to define a plurality of pixels in the display area. The pixel electrode is formed in each of the pixels. The dummy data line is formed in the peripheral area and is extended in a direction different from the extension direction of the gate lines to define a plurality of dummy pixels. The dummy pixel electrode is formed in each of the dummy pixels. A width of the dummy pixel electrode is smaller than that of the pixel electrode. The thin film transistor is formed in each of the pixels and each of the dummy pixels. The thin film transistor includes a gate electrode connected to the gate line, a source electrode connected to the dummy data line or the data line, a drain electrode formed opposite to the source electrode, and a semiconductor layer formed on the gate electrode. The semiconductor layer includes a channel formed between the source electrode and the drain electrode.

The TFT panel further includes a storage electrode line formed on the insulating substrate, and a vertical storage line connection bar formed in the peripheral area of the insulating substrate and connected to the storage electrode line. The dummy data line may be connected to the vertical storage line connection bar.

The dummy data line may be connected to a data line closest to the dummy data line.

A pixel adjacent to the dummy pixel may have a storage capacitive electrode wider than the storage capacitive electrodes of the other pixels.

A width of a pixel closet to the dummy pixel may be smaller than that of the other pixels.

A display apparatus according to another exemplary embodiment of the present invention includes the TFT substrate, a color filter substrate, and liquid crystal layer. The color filter substrate includes a second insulating substrate opposite to the first insulating substrate, a black matrix, a color filter and a common electrode, which are sequentially formed on the second insulating substrate. The liquid crystal layer is disposed between the thin film transistor substrate and the color filter substrate.

The black matrix is formed on the color filter substrate corresponding to the dummy pixel electrode. A color filter formed on the color filter substrate may include an outermost color filter corresponding to a pixel having a small width, which is disposed on an outermost region of the thin film transistor substrate.

The TFT panel according to an exemplary embodiment of the present invention includes a dummy data line formed between the peripheral area and the outer data line formed adjacent to the peripheral area. The TFT panel may prevent a brightness difference caused by a difference between a coupling capacitance of the data line adjacent to the peripheral area and the coupling capacitance of the other data lines.

When the TFT panel has a defect such as & shortened storage electrode line, the defect may be repaired through the dummy data line.

### BRIEF DESCRIPTION OF THE DRAWINGS

The above and other features of the exemplary embodiments of the present invention will he described in detail with reference to the accompanying drawings, in which:

FIG. 1A is a schematic, illustrating a portion of a display area of a TFT panel according to an exemplary embodiment of the present invention;

FIG. 1B is a cross-sectional view taken along the line Ib-Ib′ in FIG. 1;

FIG. 1C is a cross-sectional view taken along the line Ic-Ic′ in FIG. 1;

FIG. 2A is a schematic illustrating a portion of a display area of a TFT panel according to an exemplary embodiment of the present invention;

FIG. 2B is a schematic view illustrating the TFT panel in FIG. 2A; and

FIG. 3 is a schematic illustrating a portion of a display area of a TFT panel according to an exemplary embodiment of the present invention.

### DESCRIPTION OF THE EXEMPLARY EMBODIMENTS

Exemplary embodiments of the present invention are described below with reference to the accompanying drawings. This invention may, however, be embodied in many different forms and should not be construed as limited to the exemplary embodiments set forth herein. In the drawings, the size and relative sizes of layers and regions may not be drawn to scale.

It will be understood that when an element or layer is referred to as being “on,” “connected to” or “coupled to” another element or layer, it can be directly on, connected or coupled to the other element or layer or intervening elements or layers may be present. Like numbers may refer to like elements throughout.

Hereinafter, exemplary embodiments of the present invention will be described with reference to the accompanying drawings.

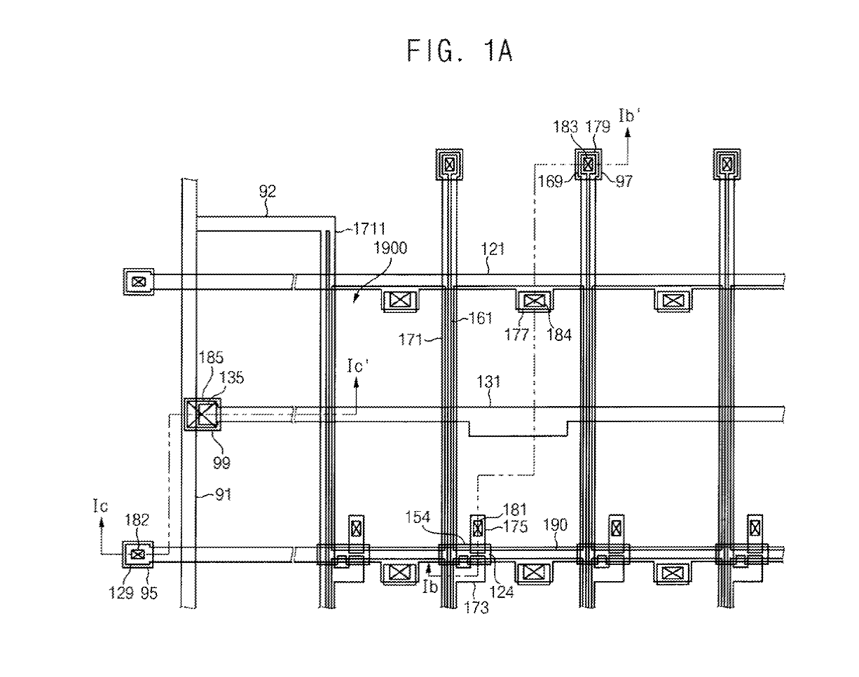

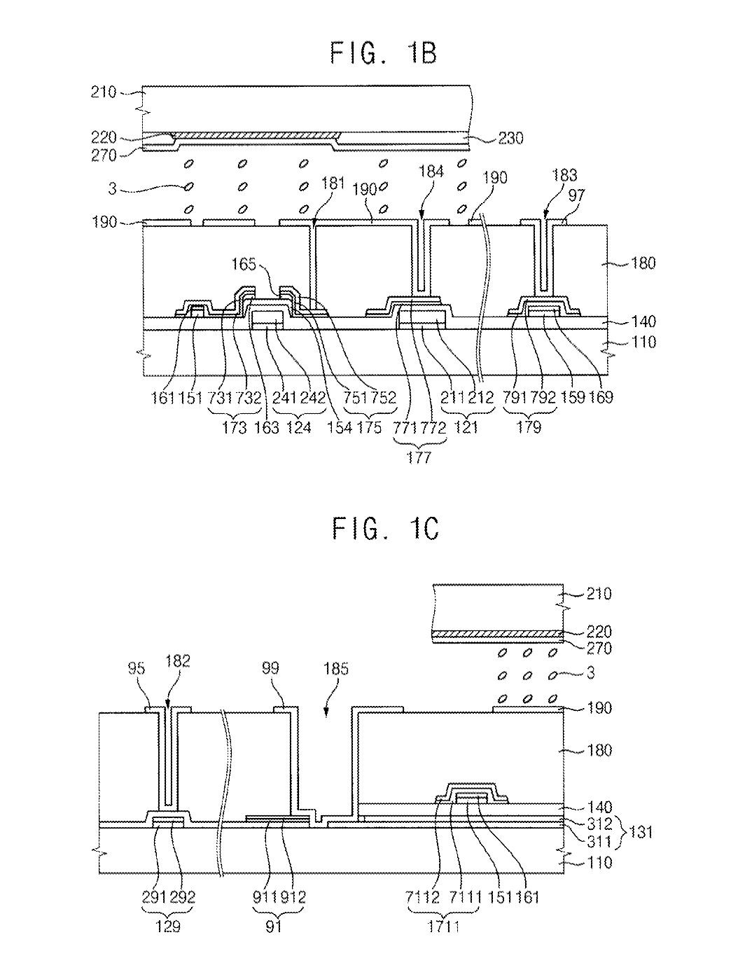

FIG. 1A illustrates a portion of a display area of a TFT panel according to an exemplary embodiment. FIG. 1B is a cross-sectional view taken along the line Ib-Ib′ in FIG. 1. FIG. 1C is a cross-sectional view taken along the line Ic-Ic′ in FIG. 1.

Referring to FIGS. 1A to 1C, gate line patterns 121, 124, and 129 are formed on a transparent insulating substrate 110. The gate line patterns 121, 124, and 129 respectively include first attaching metal patterns 211, 241, and 291 and first wiring metal patterns 212, 242, and 292 formed on the first attaching metal patterns 211, 241, and 291. The first attaching metal patterns 211, 241, and 291 strengthen an attachment of the first wiring metal patterns 212, 242, and 292 to the insulating substrate 110.

The gate line patterns 121, 124, and 129 are extended in a first direction. The gate line patterns 121, 124, and 129 include a gate electrode 124. Each of the gate line patterns 121, 124, and 129 has a terminal having a widened width for connecting to an external circuit.

A storage electrode line 131 is formed on the insulating substrate 110. The storage electrode line 131 is extended in the first direction. However, the storage electrode line 131 may have a partially curved portion. A terminal 135 of the storage electrode line 131 has a widened width for connecting to a storage electrode line 131 formed in another pixel. A plurality of storage electrode lines 131 formed in each pixel is connected to a vertical storage line connection bar 91, described below.

The storage electrode line 131 includes a first attaching metal pattern 311 and a first wiring metal pattern 312 formed on the first attaching metal pattern 311. The first attaching metal pattern 311 strengthen an attachment of the first wiring metal pattern 312 to the insulating substrate 110.

A display area is defined as an area in which a pixel corresponding to a pixel electrode 190 is disposed. A peripheral area is defined as an area in which a driving circuit for applying a signal to the display area is formed. The vertical storage line connection bar 91 is formed in the peripheral area in which the terminal 135 of the storage electrode line 131 is disposed. The vertical storage line connection bar 91 may be simultaneously formed with a data line 171. The vertical storage line connection bar 91 is extended in a second direction substantially perpendicular to the first direction. The data line 171 is substantially parallel to the vertical storage line connection bar 91. The vertical storage line connection bar 91 and the terminal 135 of the storage electrode line 131 are connected to each other by a storage contact assistance member 99 including a transparent conductive material, such as indium tin oxide (ITO), indium zinc oxide (IZO), etc.

The gate line patterns 121, 124, and 129 and the storage electrode line 131 include aluminum (Al), aluminum alloy, silver (Ag), silver alloy, copper (Cu), copper alloy, chromium (Cr), titanium (Ti), tantalum (Ta), and/or molybdenum (Mo), etc. The first attaching metal patterns 211, 241, and 291 may include chromium (Cr), molybdenum (Mo), titanium (Ti), and/or tantalum (Ta), etc., having excellent mechanical and chemical properties. The wiring metal patterns 212, 242, and 292 may include aluminum (Al), silver (Ag), and/or copper (Cu), etc, having a low resistivity. Alternatively, the gate line 121 and the storage electrode line 131 may include various kinds of metal and/or another conductive material.

According to an exemplary embodiment of the present invention, the first attaching metal patterns 211, 241, and 291 include, for example, chromium (Cr). The first wiring metal patterns 212, 242, and 292 include, for example, aluminum (Al). When the first wiring metal patterns 212, 242, and 292 including aluminum (Al) is connected to the storage contact assistance member 99 including indium tin oxide (ITO), a contact property between aluminum and ITO may be lowered. Therefore, a terminal of the first wiring metal patterns 212, 242, and 292 including aluminum (Al) is etched such that the first attaching metal patterns 211, 241, and 291 including chromium (Cr) is exposed. Thus, the first attaching metal patterns 211, 241, and 291 including chromium (Cr) is connected to the vertical storage line connection bar 91 including ITO by the storage contact assistance member 99.

A gate insulating film 140 is formed on the transparent insulating substrate 110 having the gate line patterns 121, 124, and 129 and the storage electrode lines 131 and terminal 135 of the storage electrode line 131 formed thereon.

Semiconductor layers 151, 154, and 159 and ohmic contact layers 161, 163, 165, and 169 are formed on the gate insulating film 140 corresponding to the gate electrode 124. The semiconductor layers 151, 154, and 159 include semiconductor material, such as amorphous silicon. The ohmic contact layers 161, 163, 165, and 169 include semiconductor material, such as the amorphous silicon doped with an n-typed impurity at high concentration.

Data line patterns 171, 173, 175, 177, and 179 are formed on the ohmic contact layers 161, 163, 165, and 169 and the gate insulating film 140. The data line patterns 171, 173, 175, 177, and 179 are substantially perpendicular to the gate line 121. The data line patterns 171, 173, 175, 177, and 179 and the gate line 121 define a plurality of pixel areas. The data line patterns 171, 173, 175, 177, and 179 include a source electrode 173, which is a portion of the data line 171, connected to the ohmic contact layer 163 and a drain electrode 175 spaced apart from the source electrode 173 and being formed on a ohmic contact layer 165 disposed in the opposite side of the source electrode 173 with respect to the gate electrode 124. A terminal 179 of the data line has a widened width for connecting to an external circuit. A storage capacitive electrode 177 overlapping the gate line 121 may be formed and the storage capacitance may be improved.

A first pixel is adjacent to the peripheral area and is formed in a left side of the display area. A dummy data line 1711 is formed between the first pixel and the peripheral area. The dummy data line 1711 is insulated from the gate line 121 and crosses the gate line 121. The dummy data line 1711 and the gate line 121 define a dummy pixel 1900. The dummy pixel 1900 has substantially the same shape as each of the pixels formed in the display area. For example, the dummy pixel 1900 includes the gate line 121, the dummy data line 1711, and a dummy pixel electrode formed in the peripheral area. The dummy pixel 1900 further includes a plurality of dummy thin film transistors formed in the peripheral area. The dummy thin film transistors are connected to the gate line 121, the dummy data line 1711, and the dummy pixel electrode.

A width of the dummy pixel 1900 is smaller than that of each pixel formed in the display area. A conventional TFT substrate does not include the dummy pixel. However, exemplary embodiments of the present invention include the dummy pixel. The width of the dummy pixel may be smaller than that of the pixel formed in the display to allow for a space in which the dummy pixel may be formed.

The dummy pixel 1900 and the dummy data line 1711 are formed in a left side of the display area in FIG. 1A. However, the dummy pixel 1900 and the dummy data line 1711 may be formed in the peripheral area on the right side of the display area. A width of the dummy pixel formed on the right side of the display area is smaller than the pixel formed in the display area.

A storage capacitive electrode formed in a first pixel row of the display area may be larger than storage capacitive electrodes formed in the display area, which are not included in the first pixel row. The first pixel row may therefore have the same brightness as each of the other pixel rows. When the storage capacitive electrode of the first pixel row has a broad area, an aperture ratio may be reduced. Therefore, the brightness of the first pixel row is moderated by the storage capacitive electrode's ability to shield light generated by the light source (not shown) disposed under the thin film transistor substrate.

The vertical storage line connection bar 91, substantially parallel to the data line 171, is formed on the gate insulating film 140. The dummy data line 1711 of the dummy pixel is connected to the vertical storage line connection bar 91 through a horizontal storage line connection bar 92.

The data line patterns 171, 173, 175, and 179, the storage capacitive electrode 177, and the dummy data line 1711 include second attaching metal patterns 731, 751, 791, 771 and 7111 and second wiring metal patterns 732, 752, 792, 772 and 7112. The second attaching metal patterns, 731, 751, 791, and 7111 of the data line patterns 171, 173, 175, and 179 strengthen an attachment of the second wiring metal patterns 732, 752 and 792 to the ohmic contact layers 163, 165, 169 and 161. The second attaching metal patterns 731, 751, 791, 771 and 7111 and the second wiring metal patterns 732, 752, 772 and 7112 include the above-mentioned metal. The data line including two layers has been described. However, the data line may include three layers. When the data line includes three layers, a low resistive metal is disposed in a center layer. The low resistive metal includes aluminum (Al), copper (Cu), silver (Ag), etc.

The vertical storage line connection bar 91 includes multi-layers 911 and 912 such as the data line patterns 171, 173, 175, and 179. The horizontal storage line connection bar 92 also includes multiple layers (not shown).

In the present exemplary embodiment, the dummy data line 1711 is formed in an area which is to the left side of the first data line and to the right edge of the display area. The dummy data line 1711 receives a storage signal which is applied to the vertical storage line connection bar 91.

The dummy data line 1711 and a dummy pixel row connected to the dummy data line 1711 may reduce or prevent a difference between the coupling capacitance of an outer pixel row and the coupling capacitance of the other pixel rows.

A portion of the TFT panel where the storage contact assistance member 99 makes contact, with chromium (Cr), for example at a stacking fault, may be undercut. Accordingly, the storage electrode line 131 may be opened and a stripe may be displayed.

The dummy data line 1711 may be used as a repair bar in order to prevent the stripe from being displayed.

For example, a portion where the storage electrode line 131 and the dummy data line 1711 overlaps each other is irradiated with a laser beam to remove the gate insulating film between the storage electrode line 131 and the dummy data line 1711 when a voltage potential is to be applied to the storage electrode line 131 through the dummy data line 1711. As a result, the storage electrode line 131 is connected to the dummy data line 1711. Therefore, even though the undercut portion of the storage electrode line 131 is opened by static electricity or an overcurrent, the open storage electrode line 131 may be repaired.

An overcoat film 180 is formed on the transparent insulating substrate 110. The overcoat film includes a first contact hole 181 exposing the drain electrode 175, a second contact hole 182 exposing a terminal 129 of the gate line, a third contact hole 183 exposing a terminal 179 of the data line, and a fourth contact hole 184 exposing the storage capacitive electrode 177. The overcoat film 180 further includes a fifth contact hole 185 exposing a terminal (not shown) of the storage electrode line.

A pixel electrode 190, a gate contact assistance member 95, and a data contact assistance member 97 are formed on the overcoat film 180. The pixel electrode 190 is connected to the drain electrode 175 through the first contact hole 181. The pixel electrode 190 is also connected to the storage capacitive electrode 177 through the fourth contact holes 184. The gate contact assistance member 95 is connected to the terminal 129 of the gate line through the second contact hole 182. The data contact assistance member 97 is connected to the terminal 179 of the data line through the third contact hole 183. The pixel electrode 190 might not overlap the gate and data lines 121 and 171. However, the pixel electrode 190 may partially overlap the gate and data lines 121 and 171 and an aperture ratio may be increased. The pixel electrode 190 overlapping the data line 171 may increase the aperture ratio. Signal interference between the data line 171 and the pixel electrode 190 can be reduced when the overcoat film 180 includes a material having a low dielectric constant.

The storage contact assistance member 99 is formed on the overcoat film 180. The storage contact assistance member 99 connects the terminal (not shown) of the storage electrode line with the vertical storage line connection bar 91 through the fifth contact hole 185.

As shown in FIGS. 1B and 1C, a color filter substrate is disposed on the thin film transistor substrate according to an exemplary embodiment of the present invention. The color filter substrate includes an insulating substrate 210, a black matrix 220, a color filter 230, and a common electrode 270. The black matrix 220, the color filter 230, and the common electrode 270 are sequentially formed on the insulating substrate 210. A liquid crystal is disposed between the TFT substrate and the color filter substrate to form a liquid crystal layer 3.

In the liquid crystal display apparatus, the black matrix 220 is formed at a portion of the color filter substrate, which corresponds to the dummy pixel of the thin film transistor substrate. For example, the black matrix 220 is formed in a portion of the color filter substrate, which corresponds to the pixel electrode of the dummy pixel. Therefore, even though the storage signal is applied to the dummy pixel electrode, light is not transmitted. The dummy pixel electrode forms a coupling capacitance to the first data line. Therefore, a difference of brightness between a first pixel and the other pixels is reduced or prevented.

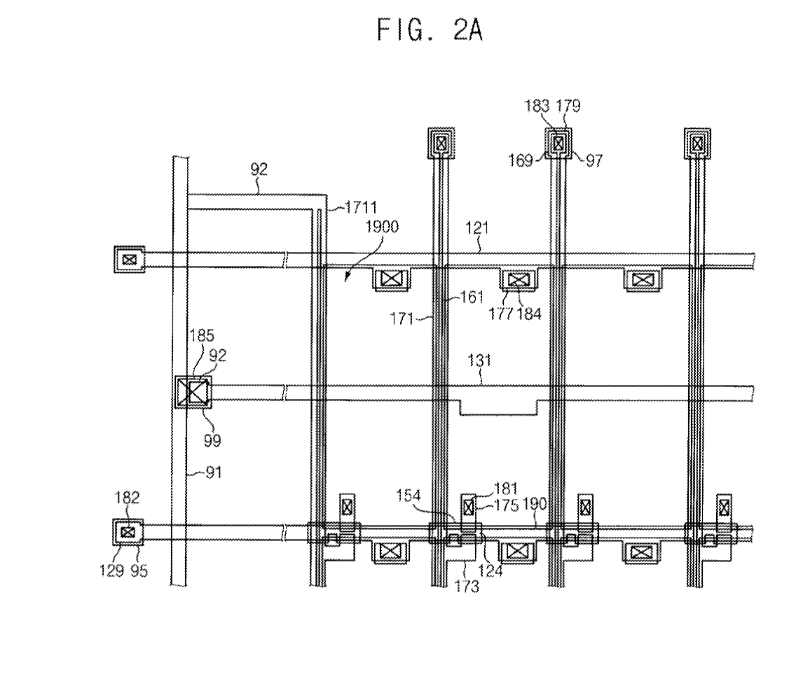

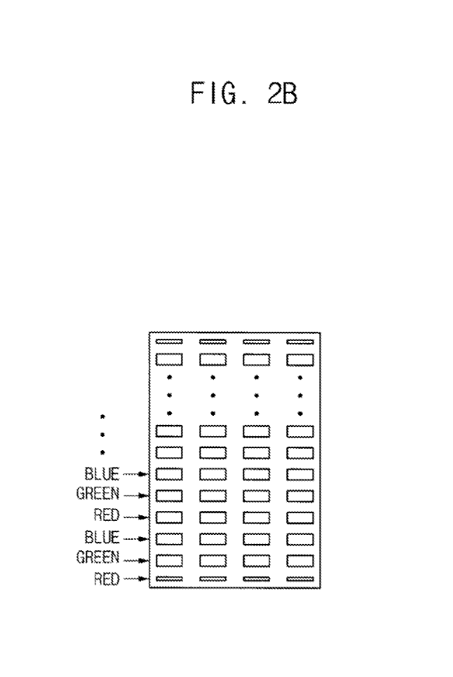

FIG. 2A illustrates a portion of a display area of a TFT panel according to an exemplary embodiment of the present invention.

FIG. 2B is a schematic view illustrating the TFT panel of FIG. 2A. Refering to FIG. 2B, red, green, and blue color filters are sequentially arranged on the color filter substrate. The first pixels and the right side outermost pixels of the display area are smaller than the other pixels of the TFT panel. When the black matrix is adjacent to the outermost pixels, the outermost pixels are brighter than the other pixels, at given brightness and chroma levels. To reduce the brightness of the outermost pixels, a width of the outermost pixel row is smaller than that of the other pixel rows.

A dummy pixel 1900 is disposed in the peripheral area adjacent to the display area. A width of the dummy pixel is smaller than that of each pixel disposed in the display area. As shown in FIG. 2A, the dummy pixel 1900 may be formed in the peripheral area disposed in a left side of the display area. Alternatively, the dummy pixel may be formed in the peripheral area disposed in a right side of the display area.

A width of each of a first pixel adjacent to the dummy pixel 1900 and a pixel (not shown) disposed in a right side of the display area is smaller than that of each of the other pixels disposed in the display area.

An area of the storage capacitive electrode formed in one of the first pixel and the pixel disposed in the right side of the display area, is larger than that disposed in each of the other pixels. The storage capacitive electrode may shield light from the light source disposed under the TFT substrate. The storage capacitive electrode includes a non-transparent metal of substantially the same size as the gate line. The storage capacitive electrode may thereby reduce the aperture. Therefore, the amount of light passing through the first pixel and the pixel disposed in the right side of the display area may be reduced. A display defect may cause the first pixel and the pixel disposed in the right side of the display area to be brighter than the other pixels. Such a display defect may be caused by virtue of the first pixel and the pixel disposed in the right side of the display area being disposed adjacent to the black matrix. According to an exemplary embodiment of the present invention, the display defect may be partially or fully corrected for by changing the area of the storage capacitive electrode.

As described above, a coupling capacitance is generated in the first pixel row and a pixel row disposed at a right side of the display area. The coupling capacitance is substantially the same as that of the other pixel when the dummy pixel 1900 and the dummy data line 1711 are formed on the TFT substrate. Therefore, the situation where the outer pixels appear brighter than the other pixels may be reduced or prevented because the coupling capacitance is not generated in the outer pixel.

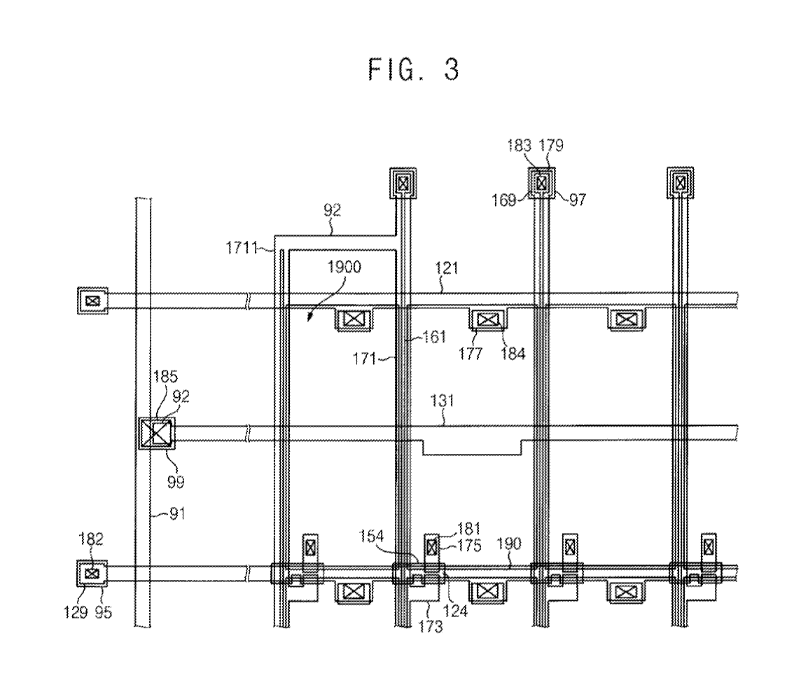

When an area of the storage capacitive electrode formed in the first pixel row is larger than that formed in the other pixel as shown in FIG. 3, the storage capacitive electrode may shield light and stabilize a kick back voltage. When the outer pixel has a small size as shown in FIG. 2B, capacitance generated by the liquid crystal may be reduced and the kick back voltage may increase. In this case, if the storage capacitive electrode has a large area, increase of the kick back voltage may be reduced or prevented.

FIG. 3 is a schematic illustrating a portion of a display area of a TFT panel according to an exemplary embodiment of the present invention.

The dummy data line 1711 shown in FIGS. 1A and 1B is connected to the vertical storage line connection bar 91. For example, the dummy data line 1711 receives a voltage substantially equal to the voltage applied to the storage capacitive line 131. However, when the storage capacitive line 131 is not formed, the dummy data line 1711 is connected to the first data line 171, as shown in FIG. 3. The voltage applied to the dummy data line 1711 may become substantially equal to the voltage applied to the data line. Many of the other features of FIG. 3 are substantially similar to corresponding features of FIGS. 1 and 2.

The TFT panel according to an exemplary embodiment of the present invention includes a dummy data line formed between the peripheral area and the outer data line formed adjacent to the peripheral area. The TFT panel may reduce or prevent a brightness difference between pixels caused by a difference of coupling capacitance between the data line adjacent to the peripheral area and the other data lines.

When the TFT panel has a shortened storage electrode line, this defect may be repaired by the dummy data line.

While the present disclosure has been particularly shown and described with reference to exemplary embodiments of the present invention, it will be understood by those of ordinary skill in the art that various changes in form and details may be made without departing from the spirit and scope of the present invention.

What is claimed is:

1. A thin film transistor (TFT) panel comprising:
an insulating substrate including a display area and a peripheral area surrounding the display area;
a plurality of gate lines formed on the insulating substrate, extending in a first direction;
a plurality of data lines insulated from the plurality of gate lines, extending in a second direction different from the first direction, and defining a plurality of pixels in the display area;
a pixel electrode formed in each of the plurality of pixels;
a dummy data line formed in the peripheral area, the dummy data line extending in a third direction different from the first direction, and defining a plurality of dummy pixels;
a dummy pixel electrode formed in each of the plurality of dummy pixels, the dummy pixel electrode having a smaller width than the pixel electrode, and
a thin film transistor formed in each of the plurality of pixels and the plurality of dummy pixels, the thin film transistor including a gate electrode connected to the plurality of gate lines, a source electrode connected to one of the dummy data line or the plurality of data lines, a drain electrode opposite to the source electrode, and a semiconductor layer formed on the gate electrode, the semiconductor layer including a channel formed between the source electrode and the drain electrode.

2. The TFT panel of claim 1, further comprising:
a storage electrode Line formed on the insulating substrate; and
a vertical storage line connection bar formed in the peripheral area of the insulating substrate and connected to the storage electrode line,
wherein the dummy data line is connected to the vertical storage line connection bar.

3. The TFT panel of claim 1, wherein the dummy data line is connected to a data line of the plurality of data lines that is closest to the dummy data line.

4. The TFT panel of claim 1, wherein a width of a pixel electrode formed in an outermost area of the plurality of pixels is smaller than a width of a pixel electrode formed in a central area of the plurality of pixels.

5. The TFT panel of claim 2, further comprising a storage capacitive electrode formed in each of the plurality of pixels and connected to the storage electrode line, wherein a width of the storage capacitive electrode formed in an outermost pixel of the plurality of pixels is smaller than a width of the storage capacitive electrode formed in a central area of the plurality of pixels.

6. A thin film transistor (TFT) panel comprising:
an insulating substrate including a display area and a peripheral area surrounding the display area;
a plurality of gate Hues formed on the insulating substrate, extending in a first direction;
a plurality of data lines insulated from the plurality of gate lines, extending in a second direction different from the first direction, and defining a plurality of pixels in the display area;
a pixel electrode formed in each of the plurality of pixels;
a storage capacitive electrode formed in each of the plurality of pixels, wherein a width of the storage capacitive electrode formed in an outermost pixel of the plurality of pixels is smaller than a width of the storage capacitive electrode formed in a central pixel of the plurality of pixels; and
a thin film transistor formed in each of the plurality of pixels and a plurality of dummy pixels, the thin film transistor including a gate electrode connected to the plurality of gate lines, a source electrode connected to one of a dummy data line or the plurality of data lines, a drain electrode opposite to the source electrode, and a semiconductor layer formed on the gate electrode, the semiconductor layer including a channel formed between the source electrode and the drain electrode.

7. The TFT panel of claim 6, wherein:
the dummy data line is formed in the peripheral area and is insulated from the plurality of gate lines, the dummy data line being extended in a third direction different from the first direction, and defining the plurality of dummy pixels;
the dummy pixel electrode is formed in each of the plurality of dummy pixels; and
a dummy thin film transistor is connected to the plurality of gate lines and the dummy data line.

8. The TFT panel of claim 6, wherein a width of a pixel electrode formed in an outermost pixel of the plurality of pixels is smaller than a width of a pixel electrode formed in a central pixel of the plurality of pixels.

9. The TFT panel of claim 7, further comprising:
a storage electrode line formed on the insulating substrate; and
a vertical storage line connection bar formed in the peripheral area of the insulating substrate and connected to the storage electrode line,
wherein the dummy data line is connected to the vertical storage line connection bar.

10. The TFT panel of claim 7, wherein the dummy data line is connected to a data line of the plurality of data lines that is closest to the dummy data line.

11. A display apparatus comprising:
a thin film transistor substrate including:
a first insulating substrate including a display area and a peripheral area surrounding the display area;
a plurality of gate lines formed on the first insulating substrate, extending in a first direction;
a plurality of data lines insulated from the plurality of gate lines, extending in a second direction different from the first direction, defining a plurality of pixels in the display area;
a pixel electrode formed in each of the plurality of pixels;
a dummy data line formed in the peripheral area, insulated from the plurality of gate lines, the dummy data line extending in a third direction different from the first direction, and defining a plurality of dummy pixels;
a dummy pixel electrode having a smaller width than the pixel electrode; and
a thin film transistor formed in each of the plurality of pixels and the plurality of dummy pixels, the thin film transistor including a gate electrode connected to the plurality of gate lines, a source electrode connected to one of the dummy data line or the plurality of data lines, a drain electrode opposite to the source electrode, and a semiconductor layer formed on the gate electrode, the semiconductor layer including a channel formed between the source electrode and the drain electrode;
a color filter substrate including:
a second insulating substrate opposite to the first insulating substrate;
a black matrix formed on the second insulating substrate and corresponding to the plurality of dummy pixels;
a color filter formed on the second insulating substrate;
a common electrode formed on the second insulating substrate; and
a liquid crystal layer disposed between the thin film transistor substrate and the color filter substrate.

12. The display apparatus of claim 11, further comprising:
a storage electrode line formed on the first insulating substrate; and
a vertical storage line connection bar formed in the peripheral area of the first insulating substrate and connected to the storage electrode line,
wherein the dummy data line is connected to the vertical storage line connection bar.

13. The display apparatus of claim 11, wherein the dummy data line is connected to a data line of the plurality of data lines that is closest to the dummy data line.

14. The display apparatus of claim 11, wherein a width of a pixel electrode formed in an outermost pixel of the plurality of pixels is smaller than a width of a pixel electrode formed in a central pixel of the plurality of pixels.

15. The display apparatus of claim 12, further comprising a storage capacitive electrode formed in each of the plurality of pixels and connected to the storage electrode line,
wherein an area of the storage capacitive electrode formed in the outermost pixel of the plurality of pixels is larger than an area of the storage capacitive electrode formed in a central pixel of the plurality of pixels.

16. A display apparatus comprising:
a thin film transistor substrate including:
a first insulating substrate including a display area and a peripheral area surrounding the display area;
a plurality of gate lines formed on the first insulating substrate, extending in a first direction;
a storage capacitive electrode formed on the first insulating substrate;
a plurality of data lines insulated from the plurality of gate lines, extending in a second direction different from the first direction, and defining a plurality of pixels in the display area;
a pixel electrode formed in each of the plurality of pixels; and
a thin film transistor formed in each of the plurality of pixels and a plurality of dummy pixels, the thin film transistor including a gate electrode connected to the plurality of gate lines, a source electrode connected to one of a dummy data line or the plurality of data lines, a drain electrode opposite to the source electrode, and a semiconductor layer formed on the gate electrode, the semiconductor layer including a channel formed between the source electrode and the drain electrode;
a color filter substrate including:
a second insulating substrate opposite to the first insulating substrate and a black matrix, a color filter, and a common electrode which are sequentially formed on the second insulating substrate;
a liquid crystal layer disposed between the thin film transistor substrate and the color filter substrate,
wherein an area of a storage capacitive electrode formed in an outermost pixel of the plurality of pixels is larger than an area of a storage capacitive electrode formed in a central pixel of the plurality of pixels.

17. The display apparatus of claim 16, wherein:
the dummy data line is formed in the peripheral area and is insulated from the plurality of gate lines, the dummy data line being extended in a third direction different from the first direction, and defining the plurality of dummy pixels; and
the dummy thin film transistor is including the gate line and the dummy data line.

18. The display apparatus of claim 16, wherein a width of a pixel electrode formed in the outermost pixel is smaller than a width of a pixel electrode formed in the central pixel.

19. The display apparatus of claim 17, further comprising:
a storage electrode line formed on the first insulating substrate; and
a vertical storage line connection bar formed in the peripheral area of the first insulating substrate and connected to the storage electrode line,
wherein the dummy data line is connected to the vertical storage line connection bar.

20. The display apparatus of claim 17, wherein the dummy data line is connected to a data line of the plurality of data lines that is closest to the dummy data line.

21. The display apparatus of claim 18, wherein a width of the color filter corresponding to the outermost pixel of the plurality of pixels is smaller than a width of the color filter corresponding to a central pixel of the plurality of pixels.
